(19) United States
(12) Patent Application Publication
(10) Pub. No.: US 2019/0254333 A1
(43) Pub. Date: Aug. 22, 2019

(54) FOOD SCRAP PROCESSING

(71) Applicant: Combs Brothers LLC, Las Vegas, NV (US)

(72) Inventors: James Combs, Las Vegas, NV (US); Clint Combs, Las Vegas, NV (US)

(21) Appl. No.: 15/902,942

(22) Filed: Feb. 22, 2018

(51) Int. Cl. A23N 17/00; A23K 10/26; A23K 10/37; A23K 40/00; A23N 17/02

(52) U.S. Cl. CPC A23N 17/004; A23K 10/26; A23N 17/02; A23K 40/00; A23K 10/37

(57) ABSTRACT

A system and method for recycling food scraps are provided. Food scraps are received into the system and is conveyed to a depacker. The depacker separates organics in the food scraps from packaging trash. Cleanliness in the depacker is controlled via a screen size. The organics are cooked in a cooker at a predetermined time and temperature to create an animal feed which is stored or delivered.

### BACKGROUND

The global population is projected to exceed 9.7 billion by 2050. Food production will need to increase by 60-110% (based on the 2005 level) or 25-70% (based on current levels) to keep pace with growing demands. How can society address the unprecedented challenge with a sustainable supply of food, energy and water (FEW), while mitigating environmental damages? Of a few key strategies widely discussed, enhancing the utilization of food already produced and cutting down waste is a viable option.

Globally, one-third of food produced for humans is never eaten but wasted, totaling 1.3 billion tons annually. Wasted food means missed opportunities to feed hungry people. Wasted food also means wasted resources such as water, energy, fertilizer, and other agricultural inputs used to produce the food. With food being wasted, the resources and environmental burdens associated with food production, e.g. biodiversity and habitat loss, soil and water degradation, and greenhouse gas (GHG) emissions are sacrificed in vain.

Recapturing and using food scraps through animal feeding, as a strategy, presents a second chance to return wasted food to the human food chain as meat, eggs, or milk. Livestock production requires a very large share of resources, consuming 35% of the world's grains. Feeding animals with properly-treated and nutrient-rich food scraps may allow replacement of feed grains, which would not only help strengthen the food-energy-water nexus sustainability but also bring forth a cascade of resource and environmental benefits.

Historically, livestock animals have functioned as the ‘bio-processor’ for utilizing agricultural byproducts and food scraps and converting them into meats, eggs, or milk for humans. But the practice lost its popularity in modern intensive animal production systems. Now, as the world strives to meet the triple challenge of food, energy, and water security amid climate change and dwindling resources, there is a growing interest in reinvigorating the practice. Strong evidence indicates that properly treated food scrapes are safe, nutritious, and palatable for animals. Successes in Japan and South Korea, each recovering roughly 40% of food waste for animal feeding, provide working models for implementing the strategy at national levels.

The U.S. and China have a major role to play in the global food-energy-water security agenda. As the largest economies and with populations ranking the 3rd and the 1st in the world, the two countries' food systems command very large amounts of resources with substantial environmental ramifications. The two nations' food systems are closely linked with each other and with the globalized world community. The strategy of using food scraps as animal feed has a potential capacity of recovering tens of millions of tons of food scraps as feed resources for animals, which in turn strengthens the sustainable supply of food, energy, and water while lowering environmental impacts. Toward this end, systems and methods for safely processing and recovering food scraps are desired.

### SUMMARY

Given the foregoing, a method and system for processing food scraps to recycle the food scraps into animal feed and/or other products is disclosed herein. According to one exemplary embodiment, a method for recycling food scraps is provided. The method may comprise receiving food scraps and conveying food to a depacker, and separating organics in the food scraps from packaging trash in the depacker. The depacker cleanliness may be controlled by way of a depacker screen size. Once organics are separated, the method may further comprise cooking the organics in a cooker at a predetermined time and temperature to create an animal feed. The animal feed may then be stored or delivered as required.

In further embodiments, the method also comprises removing rocks and metallic material from the organics via a rock trap with magnets and an in line metal detector, and centrifuging the organics into food solids, food oils, and stick water in a tricanter after the separating and prior to cooking. In this embodiment, the cooking may comprise cooking the food solids separated by the tricanter. The method may also comprise pre-cooking the organics in a pre-cooker to separate oils from the organics after the separating and prior to the centrifuging. The stick water from the tricanter may be pumped into one or more of the depacker, the pre-cooker, and a stick water storage tank, to further facilitate processing.

In some embodiments, the food scraps are received in a receiving vat having an auger at a bottom of the receiving vat, the auger transporting the food scraps to a food scraps conveyer that conveys the food scraps to the depacker. The received food scraps may also be filtered through a grease screen to separate oil from the food scraps prior to inserting the food scraps in the receiving vat. The cooker may also comprise an opening through which the organics that have been cooked are dispensed into a vat, the vat having an inclined auger at a bottom of the vat, the inclined auger dispensing the cooked organics for storage and/or delivery.

In other embodiments, a system for recycling food scraps is provided that comprises a receiving vat configured to receive food scraps and transport the food scraps to a food scraps conveyer, a depacker that receives the food scraps from the food scraps conveyer and comprises a center shaft and paddles that work with a screen to separate the food scraps into organics and non-organic trash and that disposes the non-organic trash. The system further comprises a cooker configured to cook the separated organics received from the depacker at a predetermined time and temperature and transport the organics that have been cooked for storage and/or delivery.

The system may further comprise a tricanter that receives the organics from the depacker and centrifuges the organics into food solids, food oils, and stick water. The cooker cooks the food solids separated by the tricanter. The system may also comprise a pre-cooker that receives the organics from the depacker and pre-cooks the organics to separate oils from the organics and sends the organics to the tricanter. The system may also include at least one pump that pumps the stick water into one or more of the depacker, the pre-cooker, and a stick water storage tank.

In some embodiments, the receiving vat has an auger at a bottom of the receiving vat. The auger transports the food scraps to the food scraps conveyer that conveys the food scraps to the depacker. The system may also comprise a grease screen where the received food scraps are filtered through the grease screen to separate oil from the food scraps prior to inserting the food scraps in the receiving vat. In some instances, the cooker comprises an opening through which the organics that have been cooked are dispensed into a vat, the vat having an inclined auger at a bottom of the vat, the inclined auger dispensing the cooked organics for storage and/or delivery.

### BRIEF DESCRIPTION OF THE DRAWINGS

FIG. 1 shows an overview and schematic of a food scraps processing system, according to one exemplary embodiment.

FIG. 2A shows a top view of an input portion of a food scraps processing system according to one exemplary embodiment. FIG. 2B shows a side view of the input portion of FIG. 2A.

FIG. 3A shows a top view of depacker component of a food scraps processing system according to one exemplary embodiment. FIG. 3B shows a side view of the depacker of FIG. 3A, and FIG. 3C shows a front view of the depacker of FIG. 3A

FIG. 4A shows a top view of a tricanter and cooker portion of a food scraps processing system, according to one exemplary embodiment. FIG. 4B shows a side view of the tricanter of FIG. 4A.

FIG. 5A shows a top view of a cooker and loading portion of a food scraps processing system, according to one exemplary embodiment. FIG. 5B shows a side view of the cooker and loading portion of FIG. 5A, and FIG. 5C shows a front view of the cooker and loading portion of FIG. 5A.

The components in the figures are not necessarily to scale, emphasis instead being placed upon illustrating the principles of the invention. In the figures, like reference numerals designate corresponding parts throughout the different views.

### DETAILED DESCRIPTION OF EMBODIMENTS

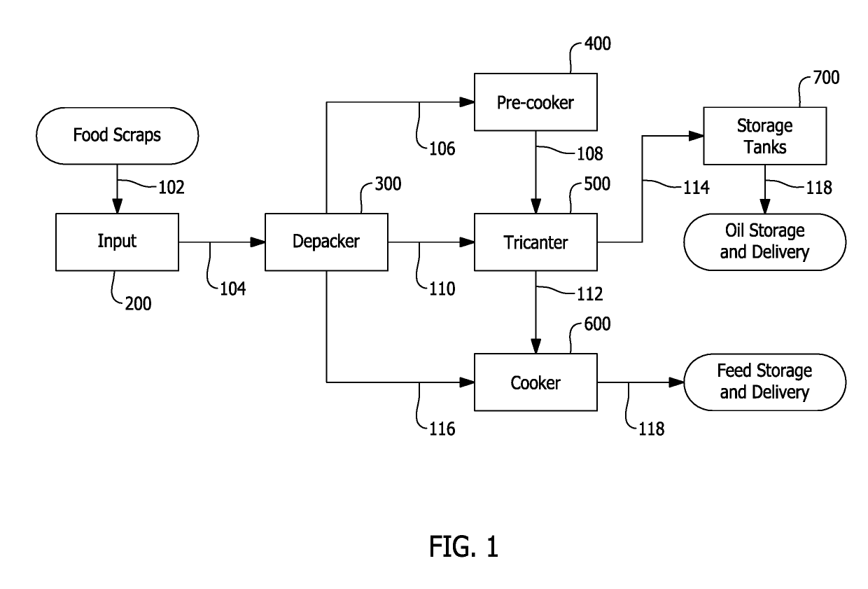

FIG. 1 shows an overview and schematic of a food scraps processing system, according to one exemplary embodiment. As shown in FIG. 1, food scraps are placed into a food scraps processing system input 200 in step 102. The input 200 may be via any suitable device to facilitate the capture of the food scraps.

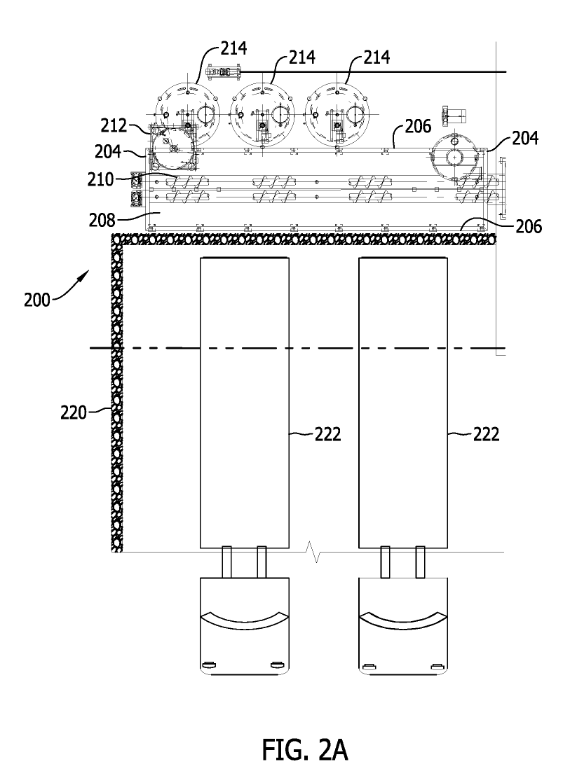

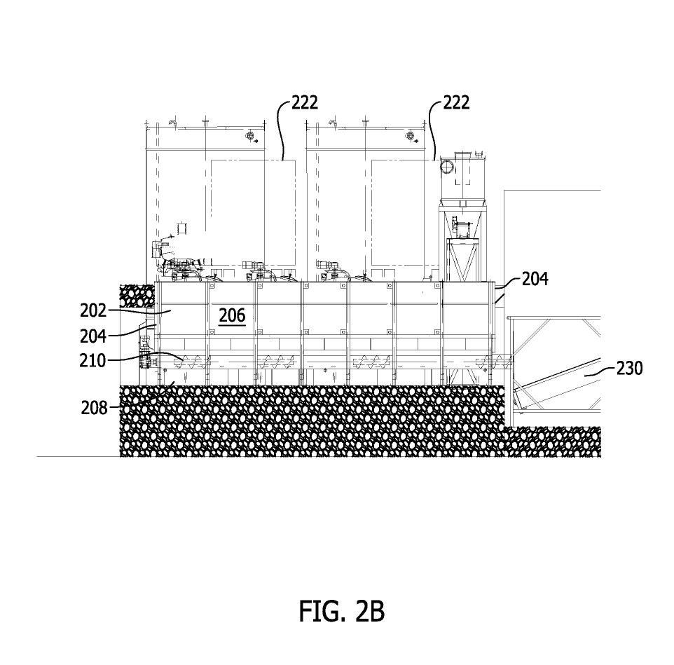

FIG. 2A shows a top view of an input portion of a food scraps processing system according to one exemplary embodiment. FIG. 2B shows a side view of the input portion of FIG. 2A. An input portion 200 in this embodiment may include a raw material dumper 202. The dumper has side walls 204 and 206 forming an open top that may be covered with a lid and in which food scraps may be dumped. A bottom surface 208 of the dumper 202 funnels food toward the augers 210. The augers 210 move the food scraps inserted into the dumper 202 towards a food scrap conveyer 230 (FIG. 2B). As illustrated in FIGS. 2A and 2B, the food scraps are pushed from left to right towards the food scrap conveyer 230.

Food scraps may be inserted into the dumper via a variety of methods. Some food scraps might include a substantial amount of oil and/or grease. It may be desirable to collect the oil and/or grease separately from the solid food scraps. Accordingly, a grease screen device 212 may be provided to separate solid food from the oil. Such oil may be stored in tanks 214.

The input portion 200 may be positioned adjacent to a loading dock 220. The loading dock 220 may be raised such that trucks 222 may easily dump food scraps into the dumper 202.

Returning to FIG. 1, the food scraps dumped into the input portion 200 is transferred to a depacker to separate the food scraps from non-organic material, such as paper, plastic, or other food packaging or garbage, in step 104.

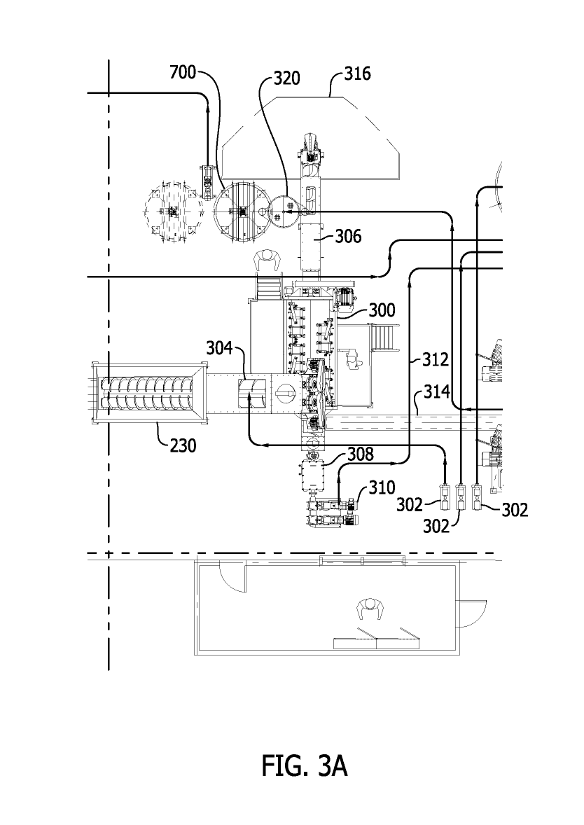

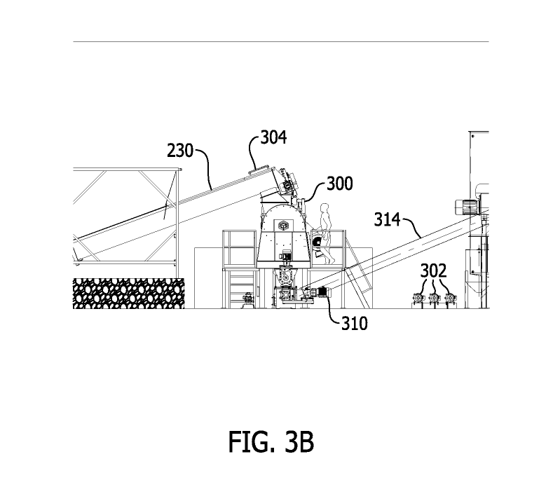

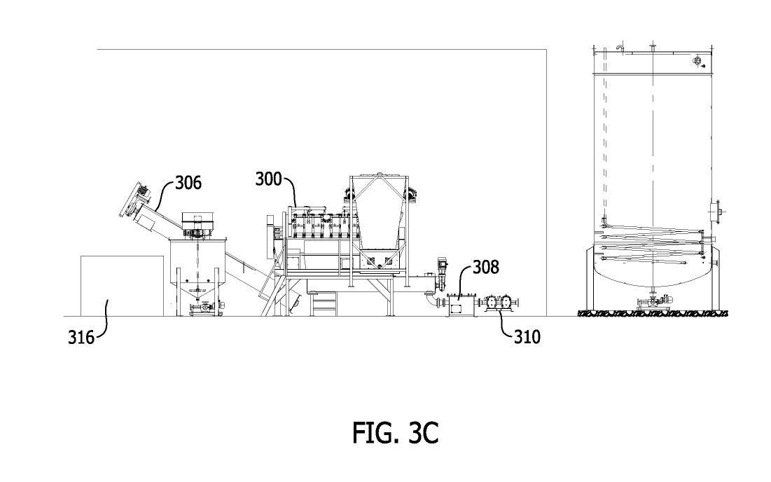

FIG. 3A shows a top view of depacker component of a food scraps processing system according to one exemplary embodiment. FIG. 3B shows a side view of the depacker of FIG. 3A, and FIG. 3C shows a front view of the depacker of FIG. 3A. The depacker 300 includes a center shaft with paddles and a screen against which the food is knocked to separate the food from the non-organics, such as food packaging. Other undesirable products may be removed, such as rinds or shells that should not be included with the feed. The cleanliness of the food that is separated may be controlled by the screen size used in the depacker 300. The depacker further homogenizes the food that is separated from the waste and makes the food “pumpable” for further processing in the system.

The food scraps loaded at the input portion 200 are conveyed via the food scrap conveyer 230 and are poured into the depacker 300. For some types of food scraps, stick water may be pumped into an opening 304 of the food scrap conveyer 230 via a stick water pump 321 to be mixed with the food scraps to enter the depacker 300. The stick water may facilitate separation between the food scraps and other waste, make the separated food “pumpable” through the remainder of the system, and add nutrients and protein to the final animal feed product.

Once separated, the trash and other items that are separated from the food are emptied from the depacker 300 through a waste conveyer 306 into a solid waste packing discharge tank 316. There, the waste may be disposed of or recycled as necessary. The organic material is led through an organic discharge conveyer 308 to a pregrinder pump 310 which pumps the organics through pregrinder piping 312. The discharge conveyer 308 may further comprise a rock trap which allows such items as glass or metals to settle and separate from the food. Magnets may be incorporated into the rock trap to further aid in the removal of magnetically attracted materials.

In some instances, the food scraps inserted into the input portion 200 are already free of other waste to the point that they may bypass the depacker. Accordingly, the depacker 300 includes a bypass conveyer 314. The depacker 300 may be configured such that the food inserted to the depacker 300 from the food scraps conveyer 230 is passed through to bypass conveyer 314. In other embodiments, the bypass conveyer 314 may be used to move separated organics directly to the tricanter 500, bypass the pre-cooker 400, as discussed in more detail below.

Returning to FIG. 1, once the food has been processed by the depacker, the process may proceed in one of three ways depending on the type of food input to the system. In step 106, the food is pumped from the depacker 300 to a pre-cooker 400. In step 108, food from the pre-cooker 400 is then pumped to the tricanter 500. Alternatively, in step 110, food may be moved from the depacker 300 directly to the tricanter 500.

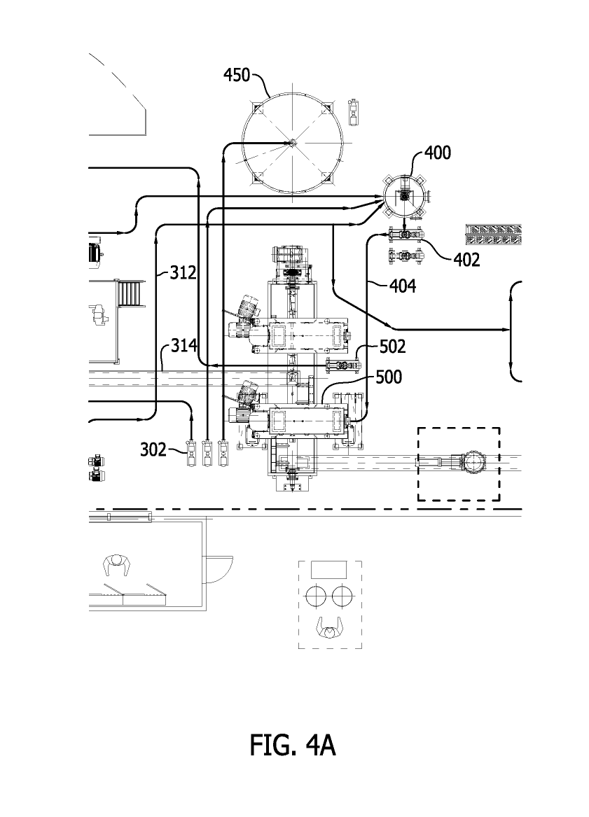

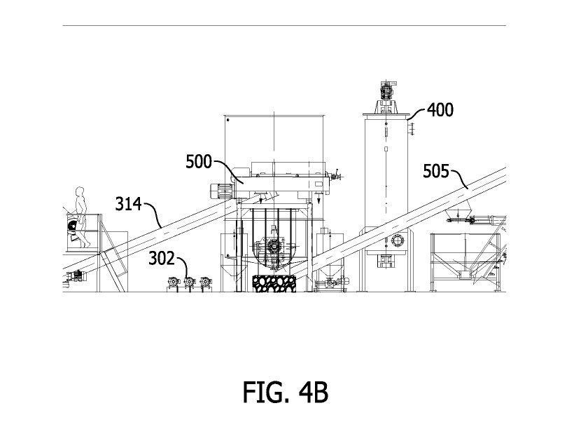

FIG. 4A shows a top view of a tricanter and cooker portion of a food scraps processing system, according to one exemplary embodiment. FIG. 4B shows a side view of the tricanter of FIG. 4A. After depacking, the organics may be pumped through the pregrinder piping 312 to the pre-cooker 400. The pre-cooker 400 prepares the food for processing in the tricanter 500. The pre-cooker heats the food up to a temperature of 160 degrees Fahrenheit. At this temperature, the oils may be separated from the food. In some instances, it may be desirable to pump stick water into the pre-cooker from the pumps 302.

The tricanter 500 receives food products from the pre-cooker via the pre-cooker pump 402 and piping 404. Alternatively, the tricanter 400 receives food products directly from the depacker 300 via the bypass conveyer 314. The tricanter 500 is a centrifuge that separates the solids of the food from a high-density liquid and a low-density liquid. In this instance, the tricanter 500 separates solid food products from water (stick water) and oils. The stick water separated from the food is pumped via the stick water pumps 302 to the depacker 300, pre-cooker 400, or to a stick water storage tank 340. The oil is pumped via oil pump 502 to a vibrating screen 320 (FIG. 3A) to filter out any possible solids and then stored in storage tanks 700 (FIG. 3A). Solid food from the tricanter is conveyed to the cooker 600 via solids conveyer 505.

Returning again to FIG. 1, as mentioned above, oils and stick water separated from the food in the tricanter 500 are conveyed to storage tanks 700 in step 114. The solids from the tricanter are conveyed to the cooker in step 112. Alternatively, the food may bypass both the pre-cooker 400 and tricanter 500 to the cooker 600 in step 116.

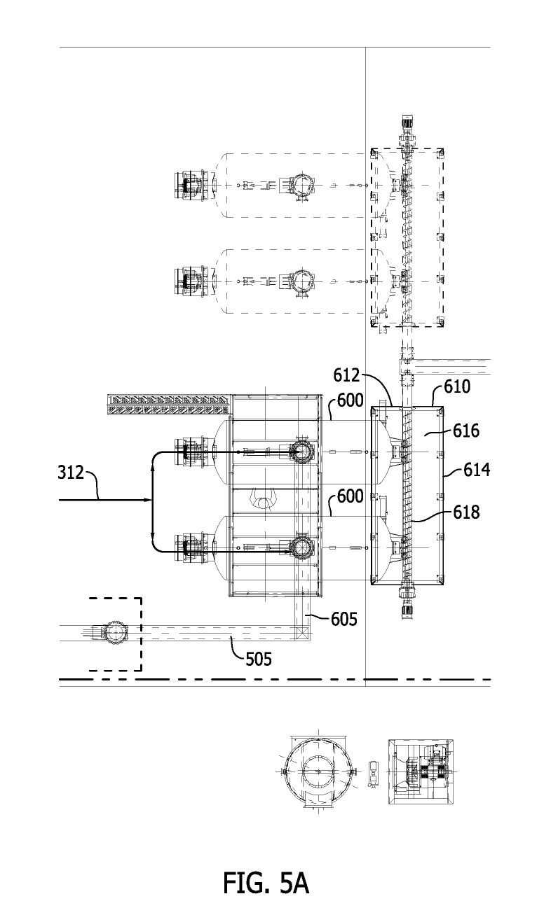

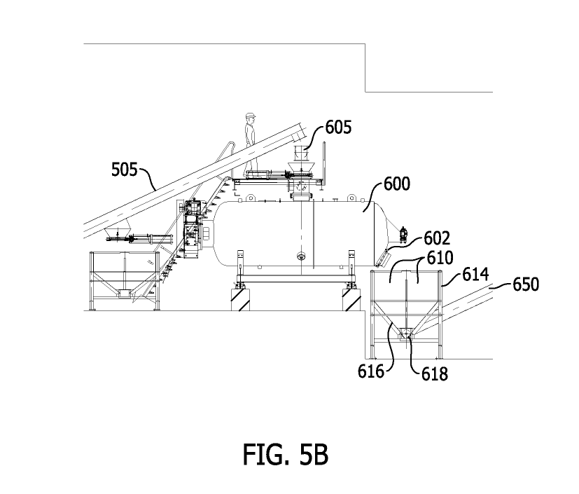

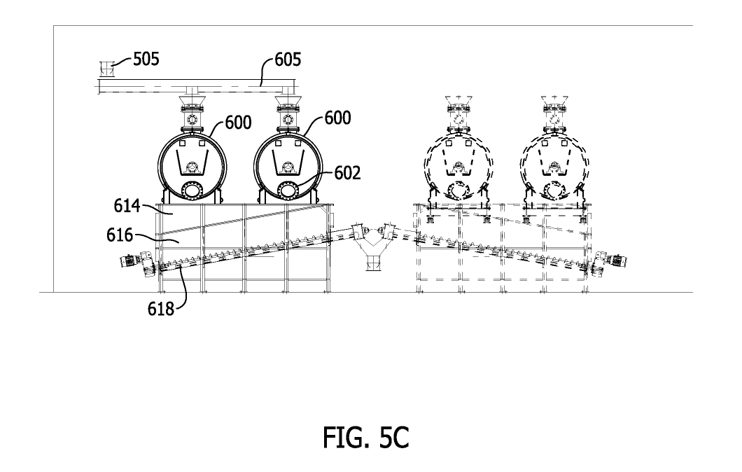

FIG. 5A shows a top view of a cooker and loading portion of a food scraps processing system, according to one exemplary embodiment. FIG. 5B shows a side view of the cooker and loading portion of FIG. 5A, and FIG. 5C shows a front view of the cooker and loading portion of FIG. 5A. The cooker 600 receives the food from the tricanter 500 via the solids conveyer 505. The solids conveyer 505 drops food to a cooker conveyer 605 that drops the food into one of the two cookers 500 shown in FIGS. 5A-5C. The cooker 600 may also receive food from the piping 312 directly from the depacker 300. The cooker 600 cooks the food according to industry standards and/or relevant rules and regulation for animal feed. For example, the cooker may cook the food for at least one-half hour at 212 degrees Fahrenheit.

Once the food has been adequately cooked, an opening 602 is opened in the cooker 600 to drop the food into vat 610. The vat 610 has sidewalls 612, 614 and a bottom 616 that guides the food towards an inclined auger 618. The inclined auger leads the food out of the vat 610 to a delivery conveyer 650.

Returning to FIG. 1, in step 118, the products including the oil and the processed food, such as animal feed is stored and/or delivered. For example, the delivery conveyer 650 may load the feed into a truck, a rail car, or other storage tank.

The above described system and method provide several advantages. The system provides a fully automated process to take food scraps and recover the food scraps into animal feed. This avoids wasting food that required a substantial amount of time and money to produce. Furthermore, oils and stick water that may be useful as biofuels and/or other applications may be extracted from the food scraps.

The process may be overseen electronically. For example, a control room with a central control computer may be connected to the separate parts of the systems to control the flow of the food through the system. In this way, valves, pumps, and other parts can be controlled with a decreased amount of manpower.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A method for recycling food scraps comprising:
receiving food scraps and conveying food to a depacker;
separating organics in the food scraps from packaging trash in the depacker and controlling cleanliness in the depacker via a screen size;
cooking the organics in a cooker at a predetermined time and temperature to create an animal feed; and
storing or delivering the animal feed.

2. The method of claim 1, further comprising centrifuging the organics into food solids, food oils, and stick water in a tricanter after the separating and prior to cooking, and wherein the cooking comprising cooking the food solids separated by the tricanter.

3. The method of claim 2, further comprising pre-cooking the organics in a pre-cooker to separate oils from the organics after the separating and prior to the centrifuging.

4. The method of claim 3, further comprising pumping the stick water into one or more of the depacker, the pre-cooker, and a stick water storage tank.

5. The method of claim 1, wherein the food scraps are received in a receiving vat having an auger at a bottom of the receiving vat, the auger transporting the food scraps to a food scraps conveyer that conveys the food scraps to the depacker.

6. The method of claim 5, wherein received food scraps are filtered through a grease screen to separate oil from the food scraps prior to inserting the food scraps in the receiving vat.

7. The method of claim 1, wherein the cooker comprises an opening through which the organics that have been cooked are dispensed into a vat, the vat having an inclined auger at a bottom of the vat, the inclined auger dispensing the cooked organics for storage and/or delivery.

8. A system for recycling food scraps comprising:
a receiving vat configured to receive food scraps and transport the food scraps to a food scraps conveyer;
a depacker comprising a center shaft with paddles and a screen that separates the food scraps into organics and non-organic trash and disposes the non-organic trash, the depacker receiving the food scraps from the food scraps conveyer; and
a cooker configured to cook the separated organics received from the depacker at a predetermined time and temperature and transport the organics that have been cooked for storage and/or delivery.

9. The system of claim 8, further comprising a tricanter that receives the organics from the depacker and centrifuges the organics into food solids, food oils, and stick water, wherein the cooker cooks the food solids separated by the tricanter.

10. The system of claim 9, further comprising a pre-cooker that receives the organics from the depacker and pre-cooks the organics to separate oils from the organics and sends the organics to the tricanter.

11. The system of claim 10, further comprising at least one pump that pumps the stick water into one or more of the depacker, the pre-cooker, and a stick water storage tank.

12. The system of claim 8, wherein the receiving vat has an auger at a bottom of the receiving vat, the auger transporting the food scraps to the food scraps conveyer that conveys the food scraps to the depacker.

13. The system of claim 12, further comprising a grease screen wherein received food scraps are filtered through the grease screen to separate oil from the food scraps prior to inserting the food scraps in the receiving vat.

14. The system of claim 8, wherein the cooker comprises an opening through which the organics that have been cooked are dispensed into a vat, the vat having an inclined auger at a bottom of the vat, the inclined auger dispensing the cooked organics for storage and/or delivery.
